(19) United States
(12) Patent Application Publication
(10) Pub. No.: US 2024/0303996 A1
(43) Pub. Date: Sep. 12, 2024

(54) DARK PLACE JUDGMENT DEVICE, DARK PLACE JUDGMENT METHOD, AND RECORDING MEDIUM

(71) Applicant: LAPIS Technology Co., Ltd., Yokohama (JP)

(72) Inventors: Kenta SATO, Yokohama (JP); Yuki IMATOH, Yokohama (JP)

(73) Assignee: LAPIS Technology Co., Ltd., Yokohama (JP)

(21) Appl. No.: 18/595,343

(22) Filed: Mar. 4, 2024

(30) Foreign Application Priority Data
Mar. 6, 2023 (JP) 2023-033998

(51) Int. Cl. G06V 20/56; G06T 5/50; G06T 7/11; G06V 10/60

(52) U.S. Cl. CPC G06V 20/56; G06T 5/50; G06T 7/11; G06V 10/60; G06T 2207/20221

(57) ABSTRACT

A dark place judgment device includes: an acquisition portion, acquiring a composite image, which is a composite of a first captured image captured in front of a vehicle with a first sensitivity and a second captured image captured in front of the vehicle with a second sensitivity; a dark place progression calculation portion, calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as the dark place progression; and a judgment portion, judging that a dark place is scheduled to be entered when the dark place progression is equal to or greater than a predetermined threshold value.

### CROSS-REFERENCE TO RELATED APPLICATION

This application claims priority under 35 USC 119 from Japanese Patent application No. 2023-033998 filed on Mar. 6, 2023, the disclosure of which is incorporated by reference herein.

### BACKGROUND

### Technical Field

The disclosed technology relates to a dark place judgment device, a dark place judgment method, and a recording medium.

### Description of Related Art

Patent Document 1 (Japanese Patent Application Laid-Open (JP-A) No. 2012-232623) discloses a lighting control device for vehicles, including an illuminance measuring means for measuring an illuminance outside a vehicle, in which a lighting control device for vehicles, mounted on the vehicle, measures the illuminance outside the vehicle and performs lighting control for exterior lights mounted on an exterior of the vehicle based on the measurement result; a judging means for judging whether or not the illuminance outside the vehicle has decreased based on the measurement results by the illuminance measuring means; a threshold value setting means for setting a lighting threshold value to turn on the exterior lights; a timing means for timing the time; and a lighting control means for controlling the lighting of the exterior lights. In the threshold value setting means, when the illuminance outside the vehicle measured by the illuminance measuring means goes below a preset first reference illuminance, the threshold value setting means starts setting a lighting threshold value higher than the illuminance outside the vehicle, and whenever the judging means judges that the illuminance outside the vehicle has decreased, the lighting threshold value is updated while maintaining the value higher than the illuminance outside the vehicle. The timing means starts timing based on the start of setting the lighting threshold value by the threshold value setting means. The lighting control means keeps the exterior lights off when a timing time by the timing means is within a preset predetermined time. When the timing time by the timing means exceeds the preset predetermined time, and the illuminance outside the vehicle measured by the illuminance measuring means is lower than the lighting threshold value set by the threshold value setting means, the exterior lights are turned on.

Patent Document 2 (Japanese Patent Application Laid-Open (JP-A) No. 1995-318644) discloses an obstacle detection device, including a lighting judging means for judging a lightness or darkness in front of a vehicle based on a shutter speed and a luminance gradation signal from an image recognition unit and outputting a signal to turn on or off a light using a CCD image-based obstacle detection system that inputs image data captured by a CCD camera to an image recognition unit to detect obstacles based on the luminance gradation and adjusts the shutter speed of the CCD camera according to a light amount by referring to a shutter speed changing map based on the luminance gradation of a sample image data; and an auto-light device that automatically turns on or off headlights according to a turn-on or turn-off signal.

Patent Document 3 (Japanese Patent Application Laid-Open (JP-A) No. 2004-243895) discloses an automatic lighting device, including a luminance distribution judging means for dividing a front image of a vehicle into two areas, a bright area of high luminance and a dark area of low luminance, using the automatic lighting system that monitors the front image of the vehicle captured by a camera and judges a lightness or darkness of the front image of the vehicle to automatically turns on or off headlights; and an automatic lighting control means that automatically turns on the headlights only when the headlights are off and the luminance distribution judged by the luminance distribution judging means judges that an entire luminance distribution is in the dark area of low luminance.

Patent Document 4 (Japanese Patent Application Laid-Open (JP-A) No. 2009-255722) discloses a driving environment detection method for detecting a driving environment of a vehicle, including capturing an image in front of the vehicle, or both the front of the vehicle and an interior of the vehicle, in a single image, in which at least two areas among a central area where an image of a central portion of the front of the vehicle exists, an upper area, which is an upper area of the central area, where an image of an upper portion of the front of the vehicle exists, and an interior area where an image of the interior of the vehicle exists, are pre-defined in the captured image as a judgment area for judging brightness and darkness; judging the brightness or darkness of the judgment area for each of the judgment areas; and detecting the driving environment of the vehicle based on the judgment result.

Patent Document 5 (Japanese Patent Application Laid-Open (JP-A) No. 2001-39210) discloses a light lighting control device, including an illuminance measuring means for measuring an illuminance around a vehicle; a photographing means for capturing images of a traveling direction of the vehicle; a dark portion detecting means for detecting a ratio of dark portions in a front view image captured by the photographing means; and a lighting control means for turning on a light based on an illuminance measurement value obtained by the illuminance measurement means when the ratio of dark portions exceeds a predetermined dark portion threshold value.

When a vehicle drives at night, in a tunnel, or on a road with poor visibility such as in dense fog, it is obligatory to turn on various types of lights, such as headlights, width lights, and taillights. In recent years, progress has been made to standardize and mandate the introduction of auto-light systems that automatically turn on various lights when a vehicle moves into an environment with poor visibility while driving.

The auto-light system currently in use uses an illumination meter mounted on the vehicle to judge whether the current location of the vehicle is in a dark place. Thus, in actual driving scenes, the timing of lights when proceeding into dark places such as tunnels is the moment the vehicle enters a dark place or several seconds after entering a dark place, making it difficult for the driver to recognize obstacles and other objects.

The disclosed technology was developed to solve the above-mentioned problems, and is intended to provide a dark place judgment device, a dark place judgment method, and a recording medium recording a dark place judgment program that may judge that a dark place is scheduled to be entered before entering the dark place.

### SUMMARY

A dark place judgment device according to the first aspect includes: an acquisition portion, acquiring a composite image, which is a composite of a first captured image captured in front of a vehicle with a first sensitivity and a second captured image captured in front of the vehicle with a second sensitivity that is lower than the first sensitivity; a dark place progression calculation portion, calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as the dark place progression; and a judgment portion, judging that a dark place is scheduled to be entered when the dark place progression is equal to or greater than a predetermined threshold value.

A dark place judgment method according to the second aspect includes: using a computer to execute processing including: acquiring a composite image, which is a composite of a first captured image captured in front of a vehicle with a first sensitivity and a second captured image captured in front of the vehicle with a second sensitivity that is lower than the first sensitivity; calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as the dark place progression; and judging that a dark place is scheduled to be entered when the dark place progression is equal to or greater than a predetermined threshold value.

A dark place judgment program recorded in a non-transient computer-readable recording medium according to the third aspect includes: using a computer to execute processing including: acquiring a composite image, which is a composite of a first captured image captured in front of a vehicle with a first sensitivity and a second captured image captured in front of the vehicle with a second sensitivity that is lower than the first sensitivity; calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as the dark place progression; and judging that a dark place is scheduled to be entered when the dark place progression is equal to or greater than a predetermined threshold value.

### BRIEF DESCRIPTION OF THE DRAWINGS

FIG. 1 is a configuration diagram of a dark place judgment system.

FIG. 2 is a configuration diagram showing the hardware configuration of the dark place judgment device.

FIG. 3 is a functional block diagram of a dark place judgment device.

FIG. 4 is a diagram showing an example of a high sensitivity captured image.

FIG. 5 is a diagram showing an example of a low sensitivity captured image.

FIG. 6 is a diagram showing an example of a composite image.

FIG. 7A is a diagram illustrating the ratio of high sensitivity pixels to pixels in the judgment area.

FIG. 7B is a diagram illustrating the ratio of high sensitivity pixels to pixels in the judgment area.

FIG. 7C is a diagram illustrating the ratio of high sensitivity pixels to pixels in the judgment area.

FIG. 8A is a diagram illustrating the ratio of high sensitivity pixels to pixels in the judgment area.

FIG. 8B is a diagram illustrating the ratio of high sensitivity pixels to pixels in the judgment area.

FIG. 8C is a diagram illustrating the ratio of high sensitivity pixels to pixels in the judgment area.

FIG. 9 is a diagram illustrating the divided areas.

FIG. 10 is a diagram illustrating the weighting coefficients.

FIG. 11 is a flowchart of the dark place judgment program.

### DESCRIPTION OF THE EMBODIMENTS

An example of the embodiment of the disclosure is described below with reference to the drawings In addition, same or equivalent components and parts are given the same reference signs in each drawing, and redundant descriptions are omitted. Further, the dimensional ratios in the drawings may be exaggerated for convenience of description and may differ from the actual ratios.

According to the disclosed technology, it is possible to judge that a dark place is scheduled to be entered before entering the dark place.

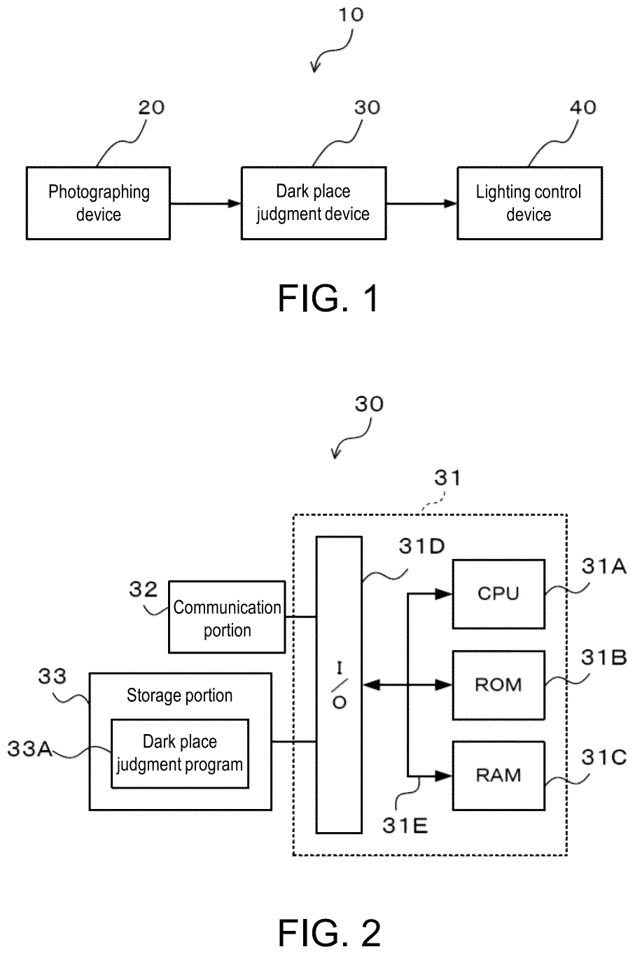

As shown in FIG. 1, the dark place judgment system 10 includes a photographing device 20, a dark place judgment device 30, and a lighting control device 40.

The photographing device 20 sequentially outputs moving images in front of a vehicle (not shown) to the dark place judgment device 30. The photographing device 20 has a so-called high dynamic range (HDR) function. The HDR function uses a high sensitivity captured image captured with high sensitivity and a low sensitivity captured image captured with low sensitivity to prevent bright areas from being overexposed and, so that the dark areas are not blackened, this is a function to synthesize a high sensitivity captured image and a low sensitivity captured image.

In this embodiment, the photographing device 20 uses the HDR function to sequentially output composite images, which are composites of high sensitivity captured images and low sensitivity captured images, to the dark place judgment device 30. In addition, each pixel in the composite image is associated with sensitivity information that indicates whether the pixel is from a high sensitivity captured image or a low sensitivity captured image.

The dark place judgment device 30 judges whether the vehicle is scheduled to enter the dark place based on the composite image output from the photographing device 20 and transmits the judgment result to the lighting control device 40.

Here, a dark place is a location where the brightness is such that the vehicle's headlights or other lighting devices need to be turned on. Examples of dark places include, but are not limited to, tunnels, forests, woodlands, and underground parking lots.

The lighting control device 40 controls the lighting of a lighting device such as headlights of the vehicle based on the judgment result of the dark place judgment device 30. Specifically, the lighting control device 40 turns on the lighting device such as the headlights of the vehicle when the judgment result of the dark place judgment device 30 is that the vehicle is scheduled to enter a dark place, and does not turn on the lighting device when the judgment result of the dark place judgment device 30 is that the vehicle is not scheduled to enter a dark place.

As described in detail below, the dark place judgment device 30 judges whether or not a dark place is scheduled to be entered before entering the dark place, rather than judging that a dark place has been entered after entering the dark place. Thus, in the case that the dark place judgment device 30 judges that the vehicle is scheduled to enter a dark place, the lighting control device 40 may turn on the lighting device of the vehicle before entering a dark place, rather than turning on the lighting device after entering a dark place. This prevents drivers from having difficulty recognizing obstacles, etc.

FIG. 2 is a block diagram showing the hardware configuration of the dark place judgment device 30 according to this embodiment. As shown in FIG. 2, the dark place judgment device 30 includes a controller 31. The controller 31 includes a device including a general computer.

As shown in FIG. 2, the controller 31 includes a central processing unit (CPU) 31A, a read only memory (ROM) 31B, a random access memory (RAM) 31C, and an input/output interface (I/O) 31D. The CPU 31A, the ROM 31B, the RAM 31C, and the I/O 31D are connected to each other via a bus 31E. The bus 31E includes a control bus, an address bus, and a data bus. Further, a communication portion 32 and a storage portion 33 are connected to the I/O 31D.

The communication portion 32 is an interface for performing data communication with the photographing device 20, the lighting control device 40, and the like.

The storage portion 33 includes a non-volatile external memory device such as a hard disk. As shown in FIG. 2, the storage portion 33 stores a dark place judgment program 33A and the like.

The CPU 31A is an example of a computer. The term “computer” used here refers to a processor in a broad sense, and includes a general-purpose processor (e.g., CPU) or a dedicated processor (e.g., graphics processing unit (GPU), application specific integrated circuit (ASIC), field programmable gate array (FPGA), and programmable logic device, etc.).

It should be noted that the dark place judgment program 33A may be realized by being stored in a non-volatile non-transitory recording medium, or distributed via a network, and installed in the dark place judgment device 30 as appropriate.

Examples of the non-volatile non-transitory recording medium include compact disc read only memory (CD-ROM), magneto-optical disk, hard disk drive (HDD), digital versatile disc read only memory (DVD-ROM), flash memory, memory card, and the like.

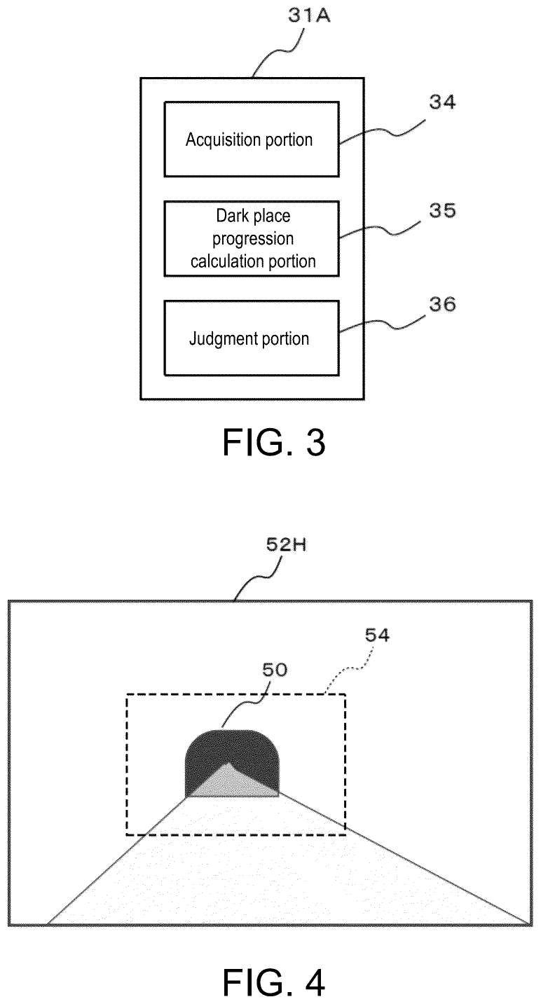

FIG. 3 is a block diagram showing the functional configuration of the CPU 31A of the dark place judgment device 30. As shown in FIG. 3, the CPU 31A is functionally equipped with an acquisition portion 34, a dark place progression calculation portion 35, and a judgment portion 36.

The CPU 31A functions as each functional portion shown in FIG. 3 by reading and executing the dark place judgment program 33A stored in the storage portion 33.

The acquisition portion 34 acquires a composite image, which is a composite of the high sensitivity captured image captured in front of a vehicle with high sensitivity and the low sensitivity captured image captured in front of the vehicle with low sensitivity, from the photographing device 20. The high sensitivity captured image is an example of a first captured image captured in front of the vehicle with a first sensitivity. Furthermore, the low sensitivity captured image is an example of a second captured image captured in front of the vehicle with a second sensitivity that is lower than the first sensitivity.

As an example, FIG. 4 shows a high sensitivity captured image 52H, which is a captured image captured while traveling on a road with a tunnel 50 in front and is captured with high sensitivity.

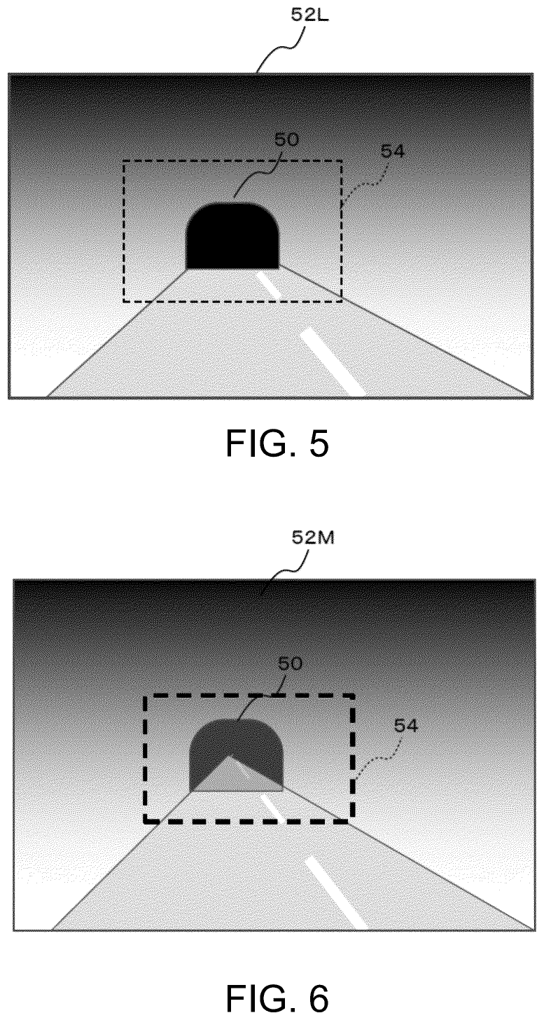

Furthermore, similarly to FIG. 4, FIG. 5 shows a low sensitivity captured image 52L, which is a captured image captured while traveling on a road with a tunnel 50 in front and is captured with low sensitivity.

As shown in FIG. 4, the high sensitivity captured image 52H is an image captured with high sensitivity, so dark areas such as the tunnel 50 are clearly expressed without being blackened compared to the low sensitivity captured image 52L. Meanwhile, for the area surrounding the tunnel 50, the image appears to be overexposed compared to the low sensitivity captured image 52L.

Also, as shown in FIG. 5, the low sensitivity captured image 52L is an image captured with low sensitivity, so dark areas such as the tunnel 50 are blackened compared to the high sensitivity captured image 52H. Meanwhile, the area surrounding the tunnel 50 is clearly expressed without overexposure compared to the high sensitivity captured image 52H.

The HDR function of the photographing device 20 generates the composite image, which is a composite of the high sensitivity captured image and the low sensitivity captured image, so that the dynamic range becomes wider, and outputs the generated composite image and the sensitivity information of each pixel in the composite image to the dark place judgment device 30. Specifically, the photographing device 20 selects pixels of the high sensitivity captured image 52H shown in FIG. 4 for dark areas such as the tunnel 50, and selects pixels of the low sensitivity captured image 52L shown in FIG. 5 for bright areas such as the area around the tunnel 50, and combines the two to generate a composite image 52M, as shown in FIG. 6. As shown in FIG. 6, the composite image 52M has a wide dynamic range because pixels from the high sensitivity captured image 52H are selected for dark areas such as the tunnel 50, and pixels from the low sensitivity captured image 52L are selected for bright areas such as the area around the tunnel 50.

The dark place progression calculation portion 35 calculates a time change amount of a ratio of a number of high sensitivity pixels of the high sensitivity pixels of the high sensitivity captured image in a predetermined judgment area or a number of low sensitivity pixels of the low sensitivity pixels of the low sensitivity captured image in the judgment area to a number of pixels of judgment pixels in the judgment area of the composite image acquired by the acquisition portion 34 as the dark place progression.

As shown in FIG. 4 to FIG. 6, the dark place progression calculation portion 35 sets, for example, a predetermined area near the center of the captured image as the judgment area 54. The reason for setting the predetermined area near the center of the captured image as the judgment area 54 is that when the front of the vehicle is captured, there is a high possibility that a dark place such as the tunnel 50 exists near the center of the captured image.

Specifically, the dark place progression calculation portion 35 calculates the ratio W of the number of high sensitivity pixels KG or the number of low sensitivity pixels TG to the number of pixels HG in the judgment area 54, where HG is the number of pixels of the judgment pixels in the judgment area 54, KG is the number of high sensitivity pixels of the high sensitivity pixels of the high sensitivity captured image 52H in the judgment area 54, and TG is the number of low sensitivity pixels of the low sensitivity pixels of the low sensitivity captured image 52L in the judgment area 54 That is, KG/HG or TG/HG is calculated as the ratio W. Then, the difference (W−Wa) between the ratio W calculated this time and the ratio Wa calculated at a time point a unit time earlier is calculated as the time change amount ΔW, and the calculated ΔW is the dark place progression AS.

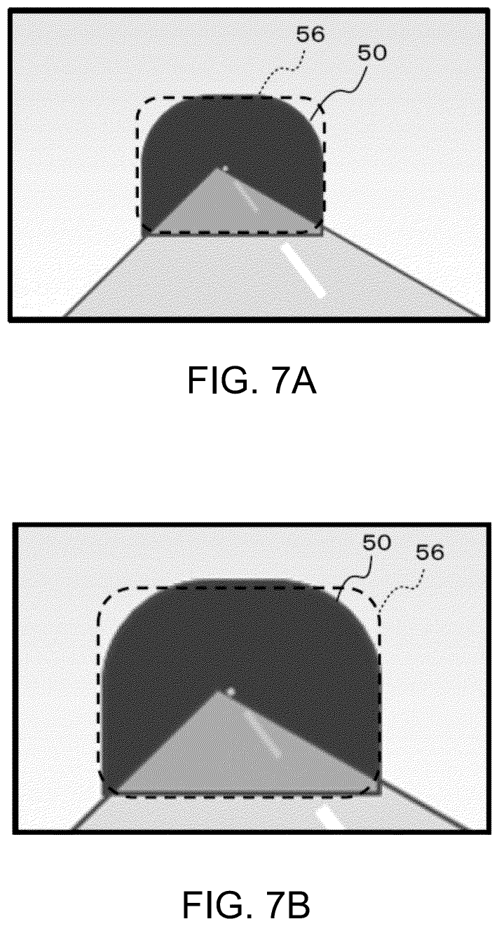

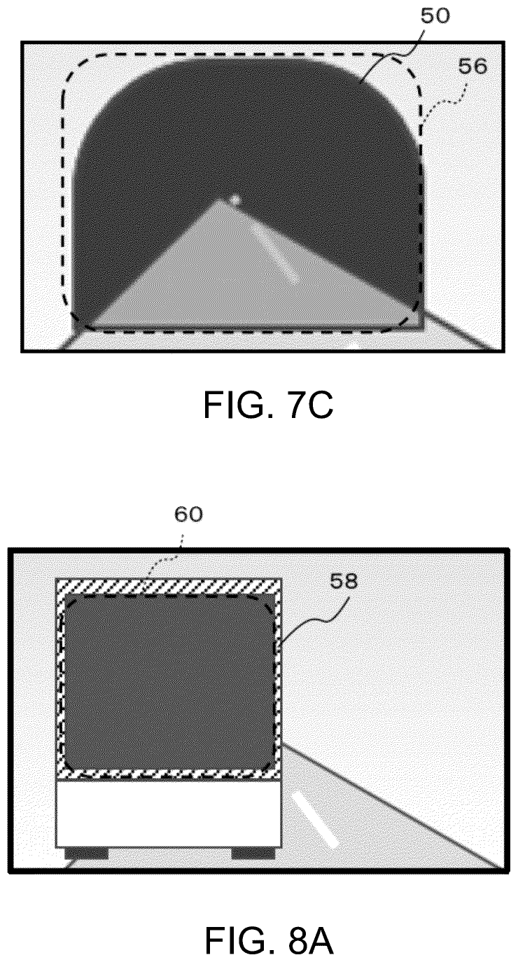

Here, it is assumed that the vehicle moves toward the tunnel and time passes in the order of FIG. 7A, FIG. 7B, and FIG. 7C. In this case, the size of the area 56 near the tunnel gradually increases. Furthermore, the area 56 near the tunnel has a higher ratio of high sensitivity pixels than low sensitivity pixels. In other words, the area 56 near the tunnel has a lower ratio of low sensitivity pixels than high sensitivity pixels.

Thus, as the time change amount ΔW of the ratio W of the number of high sensitivity pixels KG to the number of pixels HG in the judgment area 54 becomes larger, it is said that the tunnel 50 is approaching. In addition, as the time change amount ΔW of the ratio W of the number of low sensitivity pixels TG to the number of pixels HG in the judgment area 54 becomes smaller, it is said that the tunnel 50 is approaching.

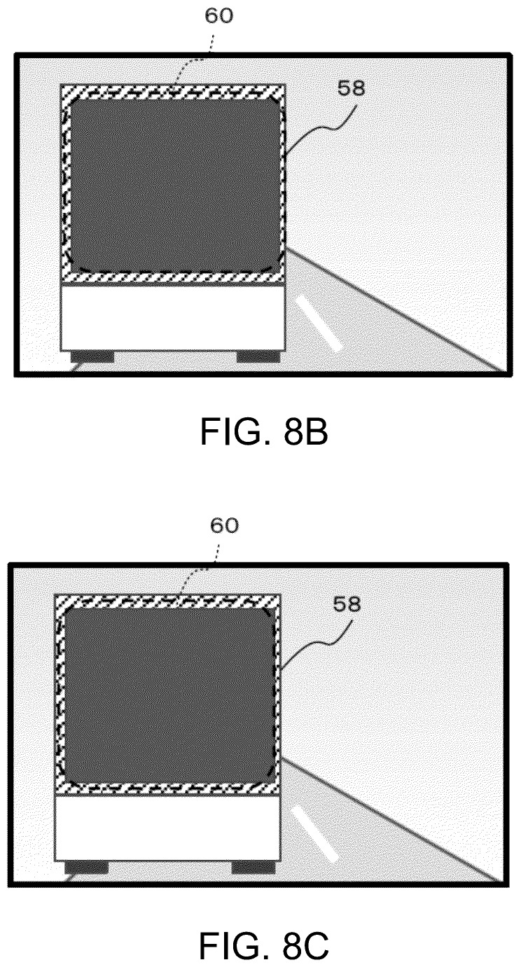

Conversely, as shown in FIG. 8A, FIG. 8B, and FIG. 8C, for example, when a light truck 58 with a hood is running in front and when time passes in the order of FIG. 8A, FIG. 8B, and FIG. 8C, the size of the area 60 of the hood hardly changes. Thus, in the case that the time change amount ΔW hardly changes, it is not said that the dark portion such as the tunnel 50 is approaching.

Thus, the judgment portion 36 judges that a dark place is scheduled to be entered when the dark place progression AS calculated by the dark place progression calculation portion 35 is equal to or greater than a predetermined threshold value. It should be noted that threshold value is set to a value that is capable of accurately judging that a dark place is scheduled to be entered, for example, based on experiment results.

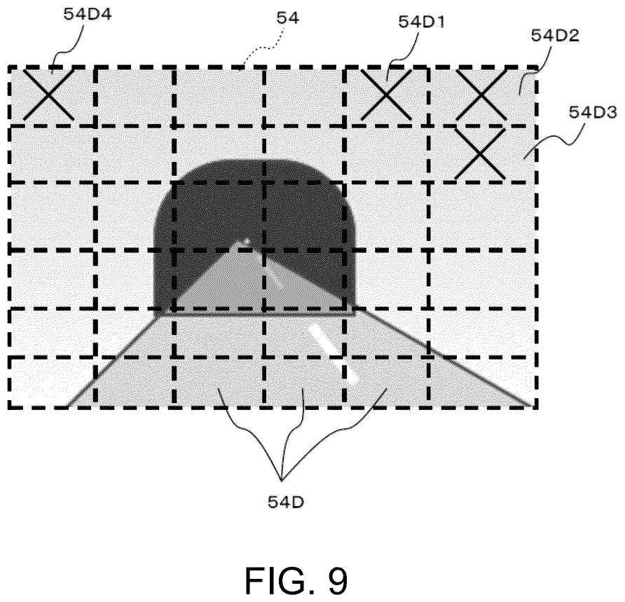

In addition, the dark place progression calculation portion 35 may exclude a portion of divided areas of multiple divided areas into which the judgment area 54 is divided from a calculation object of the time change amount ΔW and calculate the time change amount ΔW. For example, as shown in FIG. 9, the judgment area 54 is divided into multiple divided areas 54D. In the example of FIG. 9, the area is divided into 36 (6×6) divided areas 54D. Then, as shown in FIG. 9, for example, the four divided areas of the three upper right divided areas 54D1, 54D2, 54D3 and the upper left divided area 54D4 of the judgment area 54 are excluded and the time change amount ΔW is calculated. It should be noted that, for example, divided areas 54D that do not affect the judgment accuracy when judging whether or not a dark place is scheduled to be entered are preset as the divided areas 54D to be excluded.

In the case of FIG. 9, for the divided areas 54D other than the divided areas 54D1 to 54D4 set as the exclusion targets, it is judged whether each pixel is a high sensitivity pixel or a low sensitivity pixel, and the time change amount ΔW is calculated based on the judgment result.

In addition, the acquisition portion 34 acquires vehicle state information including at least one of a steering angle and a traveling speed of the vehicle, and the dark place progression calculation portion 35 may set the divided areas 54D to be excluded from the calculation object based on the vehicle state information acquired by the acquisition portion 34. For example, when the vehicle is traveling on a road that turns to the right and the tunnel 50 exists ahead, the position of the tunnel 50 in the judgment area 54 is shifted to the right as compared to when the vehicle is traveling on a straight road. In such a case, even if the divided areas 54D on the left side of the judgment area 54 is excluded from the calculation of the time change amount ΔW, it is unlikely to affect the accuracy of the judgment when judging whether or not a dark place is scheduled to be entered. Thus, when the acquired steering angle of the vehicle is such that the steering angle turns to the right, the divided areas 54D on the left side of the judgment area 54 may be excluded from the calculation object of the time change amount ΔW. Conversely, when the acquired steering angle of the vehicle is such that the steering angle turns to the left, the divided areas 54D on the right side of the judgment area 54 may be excluded from the calculation object of the time change amount ΔW. Further, the position of the divided areas 54D to be excluded from the calculation object of the time change amount ΔW may be preset according to the acquired traveling speed of the vehicle.

In addition, the dark place progression calculation portion 35 may exclude the divided areas in the center of the judgment area 54 from the calculation object of the time change amount ΔW. If a tunnel exists in the judgment area 54, it is likely that low sensitivity pixels are used because the area near the exit of the tunnel is bright. Thus, by excluding the divided areas in the center of the judgment area 54 from the calculation object of the time change amount ΔW, it is possible to suppress a decrease in the accuracy of judging whether or not a dark place is scheduled to be entered.

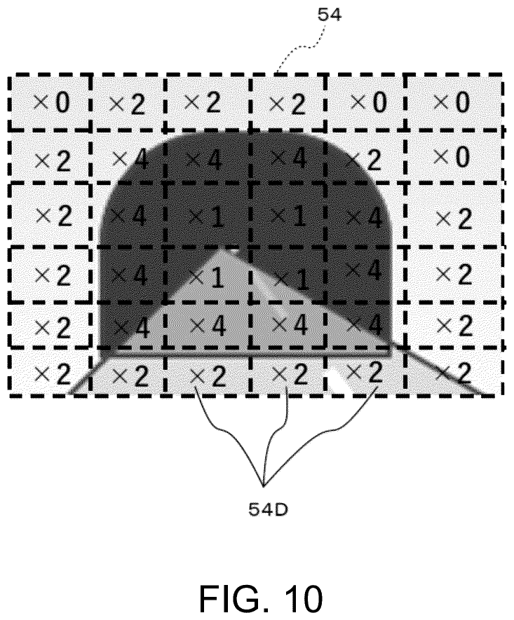

In addition, the dark place progression calculation portion 35 may calculate the time change amount ΔW by using a weighting coefficient set for each of multiple divided areas 54D in to which the judgment area 54 is divided. That is, the number of pixels KG of the high sensitivity pixels or the number of pixels TG of the low sensitivity pixels calculated for each of the divided areas 54D is multiplied by the weighting coefficient set for that divided area 54D. As a result, the number of pixels KG of the high sensitivity pixels or the number of pixels TG of the low sensitivity pixels is calculated more for the divided area 54D with a larger weighting coefficient. For example, as shown in FIG. 10, a weighting coefficient is set for each divided area 54D. In the example of FIG. 10, there are four types of weighting coefficients: “0”, “1”, “2”, and “4”, but the types of the weighting coefficients are not limited thereto.

In addition, the acquisition portion 34 may acquire vehicle state information including at least one of a steering angle and a traveling speed of the vehicle, and the dark place progression calculation portion may set the weighting coefficient based on the vehicle state information. For example, as described above, in the case that the vehicle is traveling on a road that turns to the right and the tunnel 50 exists ahead, when the acquired steering angle of the vehicle is such that the steering angle turns to the right, the divided areas 54D on the left side of the judgment area 54 may have smaller weighting coefficients compared to the weighting coefficients of the divided areas 54D on the right side. Conversely, when the acquired steering angle of the vehicle is such that the steering angle turns to the left, the divided areas 54D on the right side of the judgment area 54 may have smaller weighting coefficients compared to the weighting coefficients of the divided areas 54D on the left side. Furthermore, the arrangement of the weighting coefficients may be changed based on the previously calculated dark place progression AS.

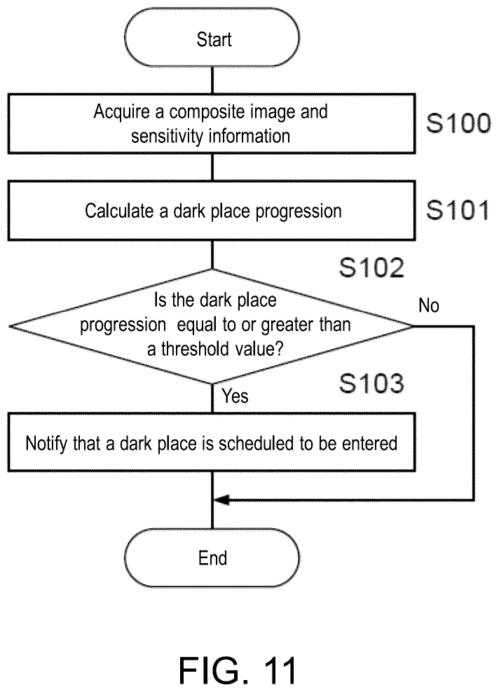

Next, with reference to FIG. 11, a flowchart of the dark place judgment program executed by the CPU 31A of the dark place judgment device 30 is described. It should be noted that the process in FIG. 11 is repeatedly executed.

In step S100, the CPU 31A acquires a composite image and sensitivity information from the photographing device 20, where the composite image is a composite of images of the front of the vehicle with high sensitivity and low sensitivity.

In step S101, the CPU 31A calculates the dark place progression AS based on the composite image 52M and the sensitivity information acquired in step S100. That is, as described above, a time change amount ΔW of a ratio of a number of high sensitivity pixels KG of the high sensitivity pixels of the high sensitivity captured image 52H in a predetermined judgment area or a number of low sensitivity pixels TG of the low sensitivity pixels of the low sensitivity captured image 52L in the judgment area to a number of pixels HG of judgment pixels in the judgment area 54 of the composite image acquired is calculated, and the calculated time change amount ΔW is taken as the dark place progression AS.

In step S102, the CPU 31A judges whether the dark place progression AS calculated in step S101 is equal to or greater than a predetermined threshold value. Then, in the case that the dark place progression AS is equal to or greater than the predetermined threshold value, the process moves to step S103. Conversely, in the case that the dark place progression AS is less than the predetermined threshold value, this routine ends.

In step S103, the CPU 31A notifies the lighting control device 40 that a dark place is scheduled to be entered. As a result, the lighting control device 40 turns on the lighting device such as the headlights of the vehicle.

In this way, in this embodiment, based on the composite image and the sensitivity information generated by the HDR function, a time change amount ΔW of a ratio of a number of high sensitivity pixels KG of the high sensitivity pixels of the high sensitivity captured image 52H in a predetermined judgment area 54 or a number of low sensitivity pixels TG of the low sensitivity pixels of the low sensitivity captured image 52L in the judgment area 54 to a number of pixels HG of judgment pixels in the judgment area of the composite image is calculated and taken as the dark place progression AS, and it is judged that a dark place is scheduled to be entered when the dark place progression AS is equal to or greater than the predetermined threshold value. As a result, it is possible to judge that a dark place is scheduled to be entered before entering the dark place and to suppress the delay in turning on headlights and the like.

With regard to the above embodiments, the following appendix are further disclosed.

### APPENDIX 1

A dark place judgment device includes: an acquisition portion, acquiring a composite image, which is a composite of a first captured image captured in front of a vehicle with a first sensitivity and a second captured image captured in front of the vehicle with a second sensitivity that is lower than the first sensitivity; a dark place progression calculation portion, calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as a dark place progression; and a judgment portion, judging that a dark place is scheduled to be entered when the dark place progression is equal to or greater than a predetermined threshold value.

### APPENDIX 2

In the dark place judgment device according to Appendix 1, the dark place progression calculation portion excludes a portion of divided areas of multiple divided areas into which the judgment area is divided from a calculation object of the time change amount and calculates the time change amount.

### APPENDIX 3

In the dark place judgment device according to Appendix 2, the acquisition portion acquires vehicle state information including at least one of a steering angle and a traveling speed of the vehicle, and the dark place progression calculation portion sets the divided areas to be excluded from the calculation object based on the vehicle state information.

### APPENDIX 4

In the dark place judgment device according to Appendix 2 or 3, the dark place progression calculation portion excludes the divided areas in a center of the judgment area from the calculation object.

### APPENDIX 5

In the dark place judgment device according to any one of Appendix 1 to Appendix 4, the dark place progression calculation portion calculates the time change amount by using a weighting coefficient set for each of multiple divided areas into which the judgment area is divided.

### APPENDIX 6

In the dark place judgment device according to Appendix 5, the acquisition portion acquires vehicle state information including at least one of a steering angle and a traveling speed of the vehicle, and the dark place progression calculation portion sets the weighting coefficient based on the vehicle state information.

### APPENDIX 7

A dark place judgment method, using a computer to execute processing including: acquiring a composite image, which is a composite of a first captured image captured in front of a vehicle with a first sensitivity and a second captured image captured in front of the vehicle with a second sensitivity that is lower than the first sensitivity; calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as a dark place progression; and judging that a dark place is scheduled to be entered when the dark place progression is equal to or greater than a predetermined threshold value.

### APPENDIX 8

A non-transient computer-readable recording medium, recording a dark place judgment program, using a computer to execute processing including: acquiring a composite image, which is a composite of a first captured image captured in front of a vehicle with a first sensitivity and a second captured image captured in front of the vehicle with a second sensitivity that is lower than the first sensitivity; calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as a dark place progression; and judging that a dark place is scheduled to be entered when the dark place progression is equal to or greater than a predetermined threshold value.

What is claimed is:

1. A dark place judgment device, comprising:
an acquisition portion, acquiring a composite image, which is a composite of a first captured image captured in front of a vehicle with a first sensitivity and a second captured image captured in front of the vehicle with a second sensitivity that is lower than the first sensitivity;
a dark place progression calculation portion, calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as a dark place progression; and
a judgment portion, judging that a dark place is scheduled to be entered when the dark place progression is equal to or greater than a predetermined threshold value.

2. The dark place judgment device according to claim 1, wherein the dark place progression calculation portion excludes a portion of divided areas of a plurality of divided areas into which the judgment area is divided from a calculation object of the time change amount and calculates the time change amount.

3. The dark place judgment device according to claim 2, wherein the acquisition portion acquires vehicle state information comprising at least one of a steering angle and a traveling speed of the vehicle, and
the dark place progression calculation portion sets the divided areas to be excluded from the calculation object based on the vehicle state information.

4. The dark place judgment device according to claim 2, wherein the dark place progression calculation portion excludes the divided areas in a center of the judgment area from the calculation object.

5. The dark place judgment device according to claim 3, wherein the dark place progression calculation portion excludes the divided areas in a center of the judgment area from the calculation object.

6. The dark place judgment device according to claim 1, wherein the dark place progression calculation portion calculates the time change amount by using a weighting coefficient set for each of a plurality of divided areas into which the judgment area is divided.

7. The dark place judgment device according to claim 6, wherein the acquisition portion acquires vehicle state information comprising at least one of a steering angle and a traveling speed of the vehicle, and
the dark place progression calculation portion sets the weighting coefficient based on the vehicle state information.

8. A dark place judgment method, using a computer to execute processing comprising:
acquiring a composite image, which is a composite of a first captured image captured in front of a vehicle with a first sensitivity and a second captured image captured in front of the vehicle with a second sensitivity that is lower than the first sensitivity;
calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as a dark place progression; and
judging that a dark place is scheduled to be entered when the dark place progression is equal to or greater than a predetermined threshold value.

9. A non-transient computer-readable recording medium, recording a dark place judgment program, using a computer to execute processing comprising:
acquiring a composite image, which is a composite of a first captured image captured in front of a vehicle with a first sensitivity and a second captured image captured in front of the vehicle with a second sensitivity that is lower than the first sensitivity;
calculating a time change amount of a ratio of a first number of pixels of first pixels of the first captured image in a predetermined judgment area or a second number of pixels of second pixels of the second captured image in the judgment area to a number of pixels of judgment pixels in the judgment area of the composite image as a dark place progression; and
judging that a dark place is scheduled to be entered when the dark place progression is equal to or greater than a predetermined threshold value.
